(19) United States
(12) Patent Application Publication
(10) Pub. No.: US 2011/0187604 A1
(43) Pub. Date: Aug. 4, 2011

(54) Two-way remote controller with hidden antenna

(76) Inventor: Tse Hsing Chen, Chung-Ho City (TW)

(21) Appl. No.: 12/656,547

(22) Filed: Feb. 3, 2010

(51) Int. Cl. H01Q 1/24

(52) U.S. Cl. 343/702

(57) ABSTRACT

A two-way remote controller with hidden antenna includes a case and a remote controller main body disposed in the case. The remote controller main body is externally provided on an upper face with a display, and a plurality of control keys at upper face or side of the casing, and internally provided near a front end with an antenna, which is extended in a direction parallel to the front end of the remote controller main body. When the remote controller main body is disposed in the case, the antenna is hidden in the case without projecting therefrom. Therefore, the remote controller can have an integral and aesthetic exterior appearance and be more conveniently carried.

### FIELD OF THE INVENTION

The present invention relates to a two-way remote controller with hidden antenna, and more particularly to a two-way remote controller that has an antenna invisible from outside of the remote controller. With the hidden antenna, the two-way remote controller can have aesthetic exterior appearance while the antenna transmitting and receiving effect thereof is not adversely affected.

### BACKGROUND OF THE INVENTION

A conventional two-way anti-theft remote controller can be used to not only transmit but also receive a signal. To enable relatively long signal transmitting and receiving ranges, the conventional two-way anti-theft remote controller usually has an antenna 30 projected from the front end of a remote controller main body 20, as shown in FIG. 1. The antenna arrangement in FIG. 1 is advantageous because a user's hand holding the remote controller would not adversely affect the antenna efficiency. However, with the antenna 30 forward projected from the remote controller main body 20, the whole remote controller has an inferior exterior appearance. To overcome the drawback of the remote controller shown in FIG. 1, a second conventional two-way anti-theft remote controller as shown in FIG. 2 is developed. On the remote controller in FIG. 2, the antenna 30 is designed to have one lateral side forming into a moderate slope toward the front end of the remote controller main body 20, so that the antenna 30 in FIG. 2 looks shorter than that in FIG. 1 while they are exactly the same in length.

FIG. 3 shows a third conventional two-way anti-theft remote controller, which has an antenna 30 with a longer portion received in the remote controller main body 20, so that the length of the antenna 30 projected from the remote controller main body 20 is shortened. However, with this arrangement, the antenna efficiency tends to be adversely affected by the user's hand holding the remote controller main body 20. Therefore, it is not desirable for the antenna 30 to have a relatively long portion received in the remote controller main body 20. FIG. 4 shows a fourth conventional two-way anti-theft remote controller, which has an antenna 30 with a largely reduced overall length. However, the length of the antenna would have influence on the antenna efficiency. The shorter the antenna is, the lower the antenna efficiency will be.

Generally, a conventional two-way anti-theft remote controller as shown in FIG. 5 is better for use. The antenna 30 for the remote controller of FIG. 5 must still properly project from the remote controller main body 20 to ensure better signal transmitting and receiving efficiency. The projected antenna 30 inevitably forms many limits to the exterior design of the two-way anti-theft remote controller and prevents a user from conveniently carrying the remote controller with him or her. In some worse condition, the projected antenna 30 is subject to breaking. Therefore, it is desirable to overcome such disadvantages of the conventional two-way anti-theft remote controllers.

Please refer to FIG. 6. In the event the antenna 30 is arranged at the right side of the remote controller main body 20, the remote controller will have reduced signal transmitting and receiving efficiency at the left side as affected by the circuit board thereof. Further, with the antenna 30 being arranged within the remote controller main body 20, the antenna transmitting and receiving frequency would be influenced by the user's hand holding the remote controller. On the other hand, as shown in FIG. 7, when the antenna 30 is arranged at the left side of the remote controller main body 20, the remote controller will have reduced signal transmitting and receiving efficiency at the right side as affected by the circuit board thereof. Similarly, with the antenna 30 being arranged within the remote controller main body 20, the antenna transmitting and receiving frequency would be influenced by the user's hand holding the remote controller.

It is therefore tried by the inventor to overcome the drawbacks in the conventional two-way anti-theft remote controllers by develop a two-way remote controller with hidden antenna, of which an antenna is invisibly disposed in the remote controller main body near a front end thereof, so that the remote controller has a visually improved exterior appearance and the antenna transmitting and receiving effect thereof is not adversely affected.

### SUMMARY OF THE INVENTION

A primary object of the present invention is to provide a long range two-way remote controller with hidden antenna, so that the remote controller can have aesthetic exterior appearance while the antenna transmitting and receiving efficiency thereof is not adversely affected.

To achieve the above and other objects, the two-way remote controller with hidden antenna according to the present invention includes a case and a remote controller main body. The remote controller main body is externally provided on an upper face with a display and a plurality of control keys and internally provided near a front end with an antenna, which is extended in a direction parallel to the front end of the remote controller main body. When the remote controller main body is disposed in the case, the antenna is hidden in the case without projecting therefrom. Therefore, the whole remote controller can be more flexibly designed to create improved visual esthetics without adversely affecting the antenna transmitting and receiving effect. With the hidden antenna, the remote controller can have an integral and aesthetic exterior appearance and be more conveniently carried.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIGS. 1 to 4 show a first, a second, a third and a fourth conventional two-way anti-theft remote controller, respectively;

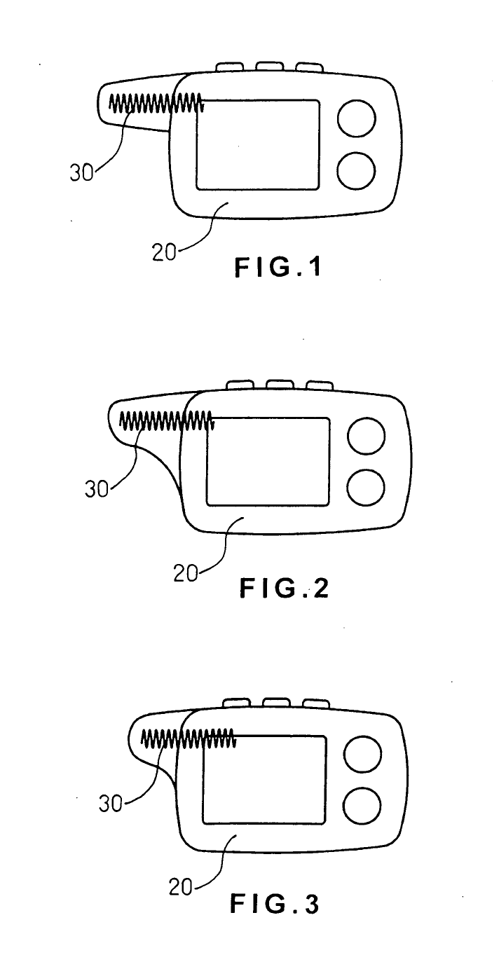

FIGS. 5, 6, and 7 show three different forms of electric wave fields generated by conventional two-way anti-theft remote controllers;

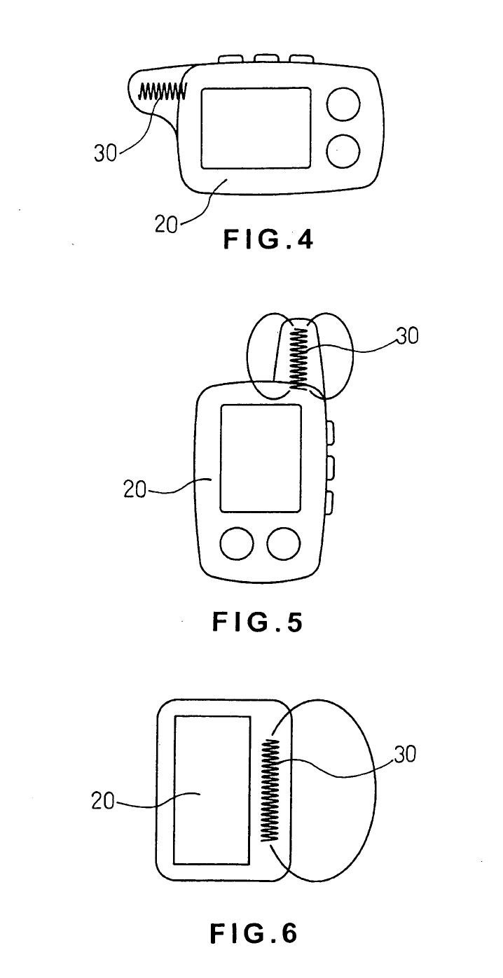

FIG. 8 schematically shows the structure of a two-way remote controller with hidden antenna according to the present invention and the form of an electric wave field thereof; and

FIGS. 9 and 10 show two embodiments of the two-way remote controller with hidden antenna according to the present invention showing different exterior structures.

### DETAILED DESCRIPTION OF THE PREFERRED EMBODIMENTS

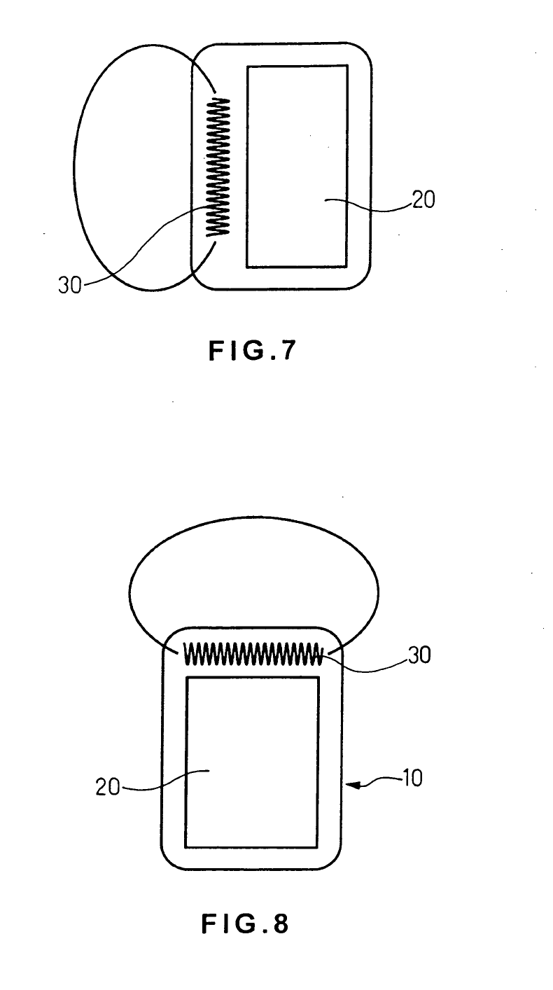

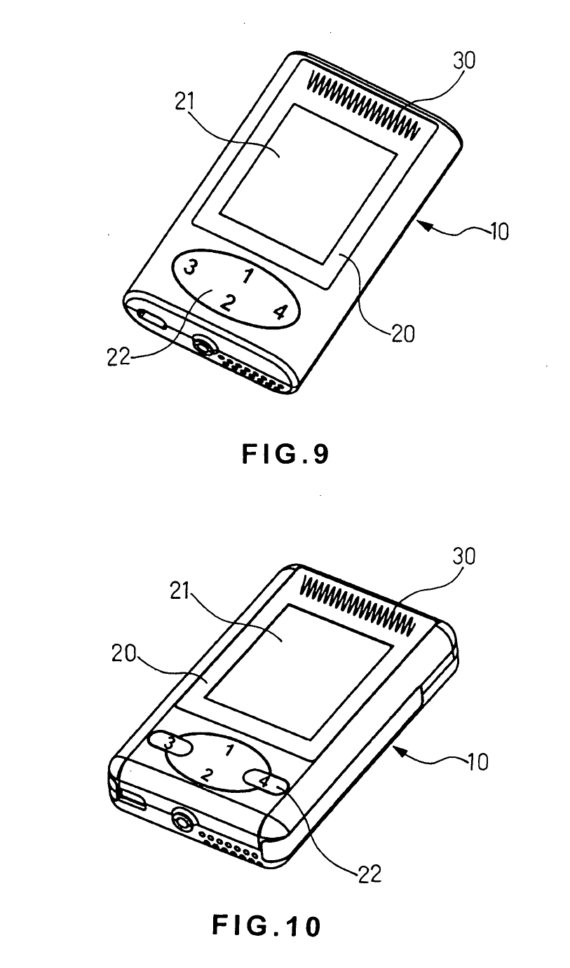

Please refer to FIG. 8 that schematically shows the structure of a two-way remote controller with hidden antenna according to the present invention and the form of an electric wave field thereof; and to FIGS. 9 and 10 that show two embodiments of the two-way remote controller with hidden antenna according to the present invention showing different exterior structures.

As shown, the two-way remote controller with hidden antenna according to the present invention includes a case 10 and a remote controller main body 20 disposed in the case 10. The remote controller main body 20 is externally provided on an upper face with a display 21 and a plurality of control keys 22, and internally provided near a front end with an antenna 30. The antenna 30 is extended in a direction parallel to the front end of the remote controller main body 20.

The remote controller main body 20 together with the antenna 30 is invisibly disposed inside the case 10, so that the remote controller can have an integral and esthetic appearance and be conveniently carried.

As can be seen from FIG. 8, in designing the remote controller, the antenna 30 is invisibly provided, that is, hidden in the remote controller main body 20 near the front end thereof, and is extended in a direction parallel to the front end of the remote controller main body 20. With this arrangement, a lengthwise space inside the remote controller main body 20 being occupied by the antenna 30 is only equal to a diameter of the antenna 30. Therefore, compared to the conventional two-way anti-theft remote controllers having an antenna that occupies a relatively long lengthwise space in the remote controller, the antenna 30 for the present invention only occupies a relatively short lengthwise space in the remote controller main body 20. Moreover, the remote controller main body 20 and the antenna 30 are completely invisibly disposed in the case 10. When the remote controller of the present invention is fully assembled, the antenna 30 thereof does not have any portion projected from the remote controller main body 20 and the case 10. Therefore, by changing the spatial arrangement of the antenna 30 in the remote controller main body 20, the case 10 can have more flexibility in its design to create changeful and beautiful exterior appearances for the two-way remote controller.

Since the hidden antenna 30 has been changed to an internal position near the front end of the case 10, the remote controller can be more conveniently carried by the user. Moreover, with the hidden antenna 30 located near the front end of the case 10, signal transmitting and receiving efficiency of the antenna 30 would not be adversely affected when the remote controller is used with the front end thereof being directed forward. When the user holds and operates the remote controller with one hand, the hidden antenna 30 located at the front end of the case 10 would not be hindered by the user's hand at all. That is, the two-way remote controller with hidden antenna according to the present invention would not have the problem of reduced antenna efficiency due to any man-made influence.

As can be seen from FIGS. 9 and 10, the case 10 for the two-way remote controller with hidden antenna according to the present invention can be differently designed with great flexibility to create changeful exterior appearances. For example, the remote controller of the present invention can be configured to look like an MP3 media player, a mobile phone, or a personal digital assistant (PDA). The remote controllers of the present invention illustrated in FIGS. 9 and 10 are further provided with a liquid crystal display (LCD) or a light-emitting diode display (LED) 21. Besides, the control keys 22 one the remote controller can also be differently arranged in active and novel manners at upper face or side of the casing.

In the present invention, different types of antenna 30 can be used, such as a helical spring antenna, a metal-sheet antenna, a laminated ceramic antenna, or a printed circuit antenna. And, the display 21 can be an LCD display or an LED display.

In brief, the two-way remote controller with hidden antenna according to the present invention has the following advantages:
(1) The antenna is hidden in the remote controller main body without projecting therefrom, allowing the remote controller to be conveniently carried.
(2) The antenna is hidden in the remote controller main body near a front end thereof, allowing the case of the remote controller to be flexibly and changefully designed to create increased visual esthetics.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A two-way remote controller with hidden antenna, comprising:
a case; and
a remote controller main body disposed in the case; the remote controller main body being externally provided on an upper face with a display, and a plurality of control keys at upper face or side of the casing, and internally provided near a front end with an antenna, and the antenna being extended in a direction parallel to the front end of the remote controller main body;
whereby when the remote controller main body is disposed in the case, the antenna is hidden in the case, allowing the whole remote controller to have an esthetic exterior appearance and be conveniently carried.

2. The two-way remote controller with hidden antenna as claimed in claim 1, wherein the antenna is selected from the group consisting of a helical spring antenna, a metal-sheet antenna, a laminated ceramic antenna, and a printed circuit board antenna.

3. The two-way remote controller with hidden antenna as claimed in claim 1, wherein the display is selected from the group consisting of an LCD display and an LED display.

4. The two-way remote controller with hidden antenna as claimed in claim 1, wherein the case has an exterior appearance looked like any one of an MP3 media player, a mobile phone, and a PDA.
